(19) United States
(12) Patent Application Publication
(10) Pub. No.: US 2008/0072648 A1
(43) Pub. Date: Mar. 27, 2008

(54) Material-Working Machine

(75) Inventor: Wolfgang Kutschker, Boeblingen (DE)

Correspondence Address: REINHART BOERNER VAN DEUREN P.C., 2215 PERRYGREEN WAY, ROCKFORD, IL, 61107, US

(73) Assignee: RAS REINHARDT MASCHINENBAU GMBH, Sindelfingen (DE)

(21) Appl. No.: 11/861,699

(22) Filed: Sep. 26, 2007

(30) Foreign Application Priority Data
Sep. 27, 2006 (DE) 10 2006 047 109.1

(51) Int. Cl. B23Q 1/25; B21D 5/04; B23Q 1/58

(52) U.S. Cl. 72/319; 269/55

(57) ABSTRACT

In order to improve a material-working machine for flat material parts, comprising a machine frame, processing tools held on the machine frame, a supporting unit, on which the flat material part can be placed for feeding to the processing tools in at least one main feed direction, and a controller for controlling a processing sequence using the processing tools, in such a way that it can be operated in an ergonomically favorable manner, it is proposed that the supporting unit extends in the main feed direction from a region toward the tool to a region remote from the tool and that the extent between the region toward the tool and the region remote from the tool is variably adjustable.

### CROSS-REFERENCE TO RELATED PATENT APPLICATIONS

This patent application claims the benefit of German Application No. 10 2006 047 109.1, filed Sep. 27, 2006, the teachings and disclosure of which are hereby incorporated in their entirety by reference thereto.

### BACKGROUND OF THE INVENTION

The invention relates to a processing machine for flat material parts, comprising a machine frame, processing tools held on the machine frame, a supporting unit, on which the flat material can be placed for feeding to the processing tools in at least one main feed direction, and a controller for controlling a processing sequence using the processing tools.

Material-working machines of this type are known from the prior art.

They have the problem that, when a supporting unit of this type is provided, operating the material-working machine is ergonomically unfavorable.

It is therefore an object of the invention to improve a processing machine of the generic type in such a way that it can be operated in an ergonomically favorable way.

### SUMMARY OF THE INVENTION

This object is achieved according to the invention by a processing machine of the type described at the beginning by the supporting unit extending in the main feed direction from a region toward the tool to a region remote from the tool and by the extent between the region toward the tool and the region remote from the tool being variably adjustable.

The variable adjustability of the supporting unit provides the possibility for an operator to be able to operate the processing machine from the sides of the supporting unit, since, in the case of flat material parts of a small extent in the main feed direction, the extent of the supporting unit can be correspondingly reduced and, on the other hand, in the case of flat material parts of a great extent in the main feed direction, the extent of the supporting unit can be increased.

In principle, it is possible to adjust the extent of the supporting unit manually. However, a particularly advantageous solution provides that the supporting unit is provided with an adjusting drive adjusting its extent between the region toward the tool and the region remote from the tool.

An adjusting drive of this type could also be manually controllable.

A particularly advantageous solution provides that the adjusting drive can be controlled by the controller.

This provides the possibility of adjusting the extent of the supporting unit already on the basis of the data available to the controller for the working operations on the flat material part.

A particularly advantageous solution provides that the extent of the supporting unit in the main feed direction can be adjusted by means of the controller to correspond to an extent in the main feed direction of the flat material part to be processed.

This provides the possibility of always adjusting the supporting unit in such a way that the flat material part to be processed can be favorably placed on it without an operator having to actively intervene and, on the other hand, the variable adjustment of the supporting unit provides the operator standing at the sides of the supporting unit, in particular in front of the region remote from the tool, with the possibility of appropriately handling the flat material part.

In particular, the controller is formed in such a way that it controls this extent of the supporting unit in the main feed direction in such a way that the flat material part to be processed can be placed fully on the supporting unit in the main feed direction.

If the flat material part is also to be positioned by the supporting unit exactly in relation to the material-working tools, the supporting unit is preferably provided with stop elements.

These stop elements could in principle be disposed independently of the means for adjusting the extent of the supporting unit.

However, a particularly advantageous solution provides that the supporting unit is provided in the region remote from the tool with stop elements for positioning the flat material part.

In principle, the stop elements could in this case also be adjustable relative to the region remote from the tool and independently of the position of the same.

However, a particularly advantageous solution provides that the stop elements are disposed in a positionally fixed manner in relation to the region remote from the tool and that positioning of the stop elements is effected by variation of the extent of the supporting unit in the main feed direction.

In this respect, the variation of the extent of the supporting unit in the main feed direction may be used not only to optimize the supporting possibility for the flat material but at the same time be used to position the stop elements at an appropriate distance from the processing tools, so that the position of the flat material can be predetermined exactly by the stop elements, and consequently the adjustability of the region remote from the tool by the controller offers numerous advantages.

It is particularly advantageous in this respect if a number of stop elements at different distances from the processing tools are provided at the end region remote from the tool.

These multiple stop elements provide the possibility of reducing the adjusting displacement for the position of the stop elements, since different basic distances from the processing tools can already be predetermined by using the different stop elements.

A particularly advantageous solution in this respect provides that the various stop elements can be individually activated by the controller, so that the stop element that is the most advantageous for the processing is already activated by the controller and all that is then required is for the position of this stop element with respect to the processing tool to be finely adjusted by moving the region remote from the tool.

In principle, it is also conceivable to provide the entire processing machine with a supporting unit that is variably adjustable in the main feed direction.

However, in the case of individual processing operations, in particular for the handling of the flat material parts by an operator, it is advantageous if a supporting device that is invariable with respect to its extent in the main feed direction is disposed in a transverse direction with respect to the main feed direction on one side of the adjustable supporting unit.

An invariable support of this type can be favorably used in particular for feeding flat material parts to the supporting unit.

A further advantageous solution provides for a supporting device that is invariable in the main feed direction to be disposed on both sides of the variable supporting unit.

In the simplest case, supporting devices of this type may be formed as conventional supporting tables for flat material parts.

No further details have been provided so far with regard to the structural form of a supporting unit that is variably adjustable in the main feed direction.

So, an advantageous solution provides that the variable supporting unit has a cross member disposed in the region remote from the tool and extending transversely in relation to the main feed direction.

A cross member of this type consequently defines the position of the region remote from the tool in a simple way.

In order to guide this cross member adjustably in the main feed direction, it is preferably provided that the cross member is guided on lateral guides extending in the main feed direction.

The guides in this case lie for example laterally of the supporting region defined by the variable supporting unit.

In order to be able to move the cross member in the main feed direction, it is preferably provided that the cross member is displaceable in the main feed direction, driven by the adjusting drive.

In this respect, it would be conceivable for example to dispose the adjusting drive in a stationary manner.

A structurally particularly simple and advantageous solution provides that the adjusting drive is disposed on the cross member, and consequently can be moved along with the cross member.

Furthermore, no further details have been provided in connection with the explanation so far of the supporting unit according to the invention as to how the supporting unit is to be formed between the region toward the tool and the region remote from the tool.

In principle, it would be conceivable not to provide any additional supports for the flat material parts between the two regions.

In order, however, to facilitate the handling of the flat material parts, in particular to prevent one of the flat material parts from falling through between the region toward the tool and the region remote from the tool, it is preferably provided that intermediate supporting elements are disposed between the region remote from the tool and the region toward the tool.

Intermediate supporting elements of this type could, for example, be constituted by separate devices between the region toward the tool and the region remote from the tool—depending on the distance between them.

However, a particularly advantageous solution provides that the intermediate supporting elements are coupled with a movement of the region remote from the tool in the main feed direction.

A solution that can be structurally realized particularly suitably provides that the intermediate supporting elements can be moved into various positions between the region toward the tool and the region remote from the tool when there is movement of the region remote from the tool in the main feed direction.

The intermediate supporting elements could for their part be movably guided on guides especially provided for them.

However, it is structurally advantageous if the intermediate supporting elements are guided on the guides for the cross member.

Guidance of this type may provide that guides especially provided for the intermediate supporting elements are held on the guides for the cross member or that the intermediate supporting elements are directly guided themselves in the guides for the cross member.

In particular whenever invariable supporting devices are provided laterally of the supporting unit in the main feed direction, it is advantageous when providing a cross member if the cross member extends up to and into the invariable supporting devices.

In this respect, the cross member may be used in a wide variety of ways within the invariable supporting devices.

One possibility provides that the cross member carries stop elements in the region of the invariable supporting devices, so that variably adjustable stop elements are also available in the region of the invariable supporting devices, in order to position the workpiece exactly.

No further details have been provided in connection with the explanation so far of the individual features of the material-working machine according to the invention. So, in particular, the material-working tools could be, for example, punching or bending and pressing tools.

A particularly advantageous solution provides that the processing tools are pivoting bending or folding tools for flat material parts.

In particular, it is advantageous in this respect if the processing tools are supported by a pivotable folding beam as well as an upper beam and a lower beam for clamping the flat material part in place.

In particular in the case of folding with a folding beam, safety requirements demand that, wherever possible, an operator must not be allowed in the region of the pivotable folding beam.

For this reason, the solution according to the invention proves to be particularly advantageous in the case of folding, since it provides the possibility of allowing the operator to operate, monitor and control the processing machine from the side of the region remote from the tool.

In this case, it is advantageous for safety reasons if the folding beam can be moved in a bending space protected by a housing.

In this case, it is therefore particularly advantageous if an operating side of the processing machine is provided on a side of the machine frame that is toward the supporting unit.

For example, it is provided in this case that the machine frame carries an operating unit for the controller on a side toward the supporting unit.

However, it would also be conceivable for the supporting unit itself to carry the operating unit for the controller.

The operator unit is preferably disposed in such a way that it is accessible in an ergonomically favorable manner for an operator standing in front of the region of the supporting unit that is remote from the tool, that is to say is within reach of the operator standing at this location.

It is possible for the processing machine to be operated in an ergonomically particularly favorable manner if an operating element that can be moved along with the region remote from the tool and with which, for example, the individual processing operations can be initiated, is provided for an operator.

Further features of the invention are the subject of the following description and the graphic representation of several exemplary embodiments.

### BRIEF DESCRIPTION OF THE DRAWINGS

FIG. 1 shows a perspective representation of a material-working machine according to the invention with a supporting unit in an intermediate position between the minimum extent and the maximum extent;

FIG. 2 shows a perspective representation of the processing machine with the supporting unit at the minimum extent;

FIG. 3 shows a cross-section through the first exemplary embodiment of the processing machine according to the invention at the maximum extent of the supporting unit;

FIG. 4 shows a partial representation of the first exemplary embodiment of the supporting unit according to the invention with cross members and intermediate cross members;

FIG. 5 shows a section along line 5-5 in FIG. 4;

FIG. 6 shows a section along line 6-6 in FIG. 5;

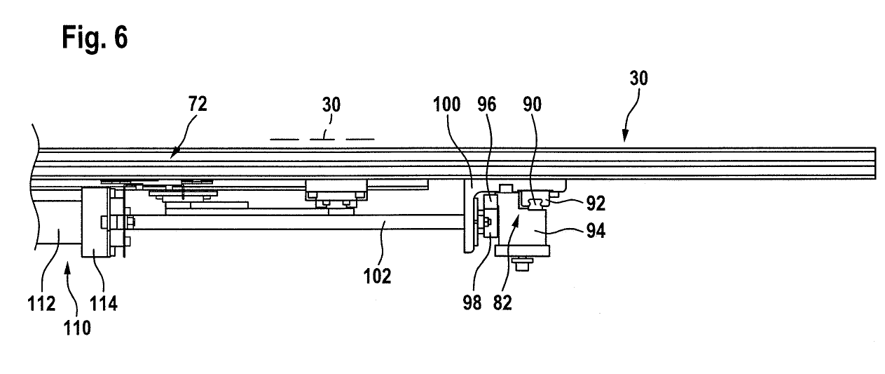

FIG. 7 shows a representation similar to FIG. 4 at the minimum extent of the supporting unit;

FIG. 8 shows a perspective representation similar to FIG. 4 in the case of a second exemplary embodiment of the processing machine according to the invention and

FIG. 9 shows a perspective representation similar to FIG. 7 in the case of the second exemplary embodiment of the processing machine according to the invention.

### DETAILED DESCRIPTION OF THE INVENTION

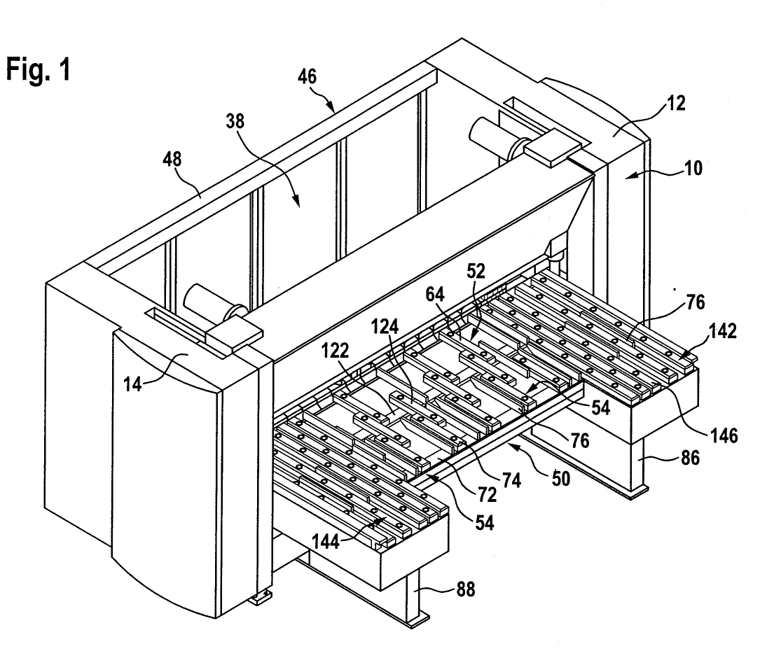

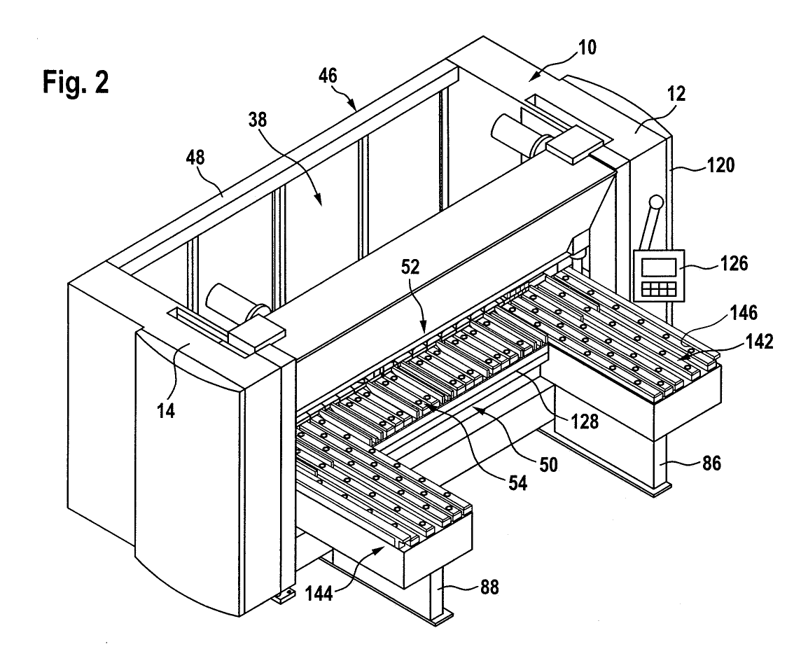

A first exemplary embodiment of a material-working machine, represented in FIGS. 1 and 2, comprises a machine frame 10 with two stands 12 and 14, between which there extends a lower beam 20, which is preferably fixedly connected to the stands 12 and 14, and also an upper beam 22, which is movable in a direction 24 relative to the lower beam 20, in order to be able to push a flat material part 26 in between the upper beam 22 and the lower beam 20 and also in order to be able to clamp it firmly between the upper beam 22 and the lower beam 20.

In this case, the lower beam 20 acts with a lower beam tool 21 and the upper beam 22 acts with an upper beam tool 23 on the flat material part 26, in order to clamp it in place.

The flat material part 26 can in this case be positioned and displaced in a supporting plane 30.

For bending the flat material part 26 clamped in between the upper beam 22 and the lower beam 20, a folding beam is provided, designated as a whole by 32, which is pivotable about a geometrical axis 34 relative to the machine frame 10, so that a bending tool 36 of the folding beam 32 is capable of bending a protruding leg 40 of the flat material part into a bending space 38.

The folding beam 32 is in this case preferably disposed and formed in such a way that bending of the leg 40 is possible in a direction 42 from top to bottom or in a direction 44 from bottom to top.

For this purpose, a movement of the folding beam is performed for example in a way corresponding to European Patent 0 497 780. As represented in FIGS. 1 and 2, the bending space 38 is not freely accessible, but is protected by a housing 46, which encloses the bending space 38 both in the region of the stands 12 and 14 and by a wall 48 disposed at a distance from the lower beam 20 and the upper beam 22, and consequently prevents access to the bending space 38 by personnel during the bending of the flat material parts.

In order to be able to position the flat material 36 exactly for the bending in the supporting plane 30, a supporting unit is provided, designated as a whole by 50 and having a region 52 toward the tool and a region 54 remote from the tool, which regions are disposed at a distance from one another in a main feed direction 56, which for its part runs parallel to the supporting plane 30 and transversely, preferably perpendicularly, in relation to the axis 34.

In this case, the region 52 toward the tool is preferably fixedly connected to the machine frame 10 and has, for example, a cross member 62, which is supported in particular on the lower beam 20 and carries supporting strips 64 for the flat material part 26 extending parallel to the main feed direction 56.

Furthermore, the region 54 remote from the tool has a cross member 72, which likewise carries on the one hand supporting strips 74 extending parallel to the main feed direction 56 and on the other hand stop strips 76.

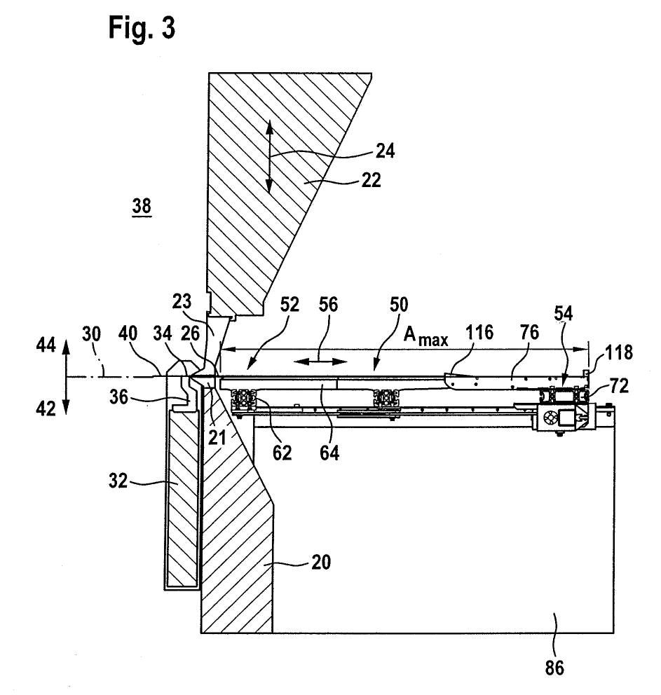

According to the concept of the invention, the region 54 of the supporting unit 50 that is remote from the tool, and in particular the cross member 72, is movable in the main feed direction 56 toward the lower beam 20 or movable away from it, so that an extent A of the supporting unit 50 is variable between a minimum extent Aₘᵢₙ, represented in FIG. 2, and a maximum extent Aₘₐₓ, represented in FIG. 3, in order always to obtain an optimum extent of the supporting unit 50 for the placement of the flat material part 26 to be processed.

In particular, this variation of the extent of the supporting unit 50 in the main feed direction 56 can be achieved by the cross member 72 being movable in the main feed direction 56.

For this purpose, two longitudinal guides 82 and 84 are provided at a distance from one another in a transverse direction 76 running transversely in relation to the main feed direction 56, mounted on base frames 86, 88 and extending parallel to the main feed direction 56.

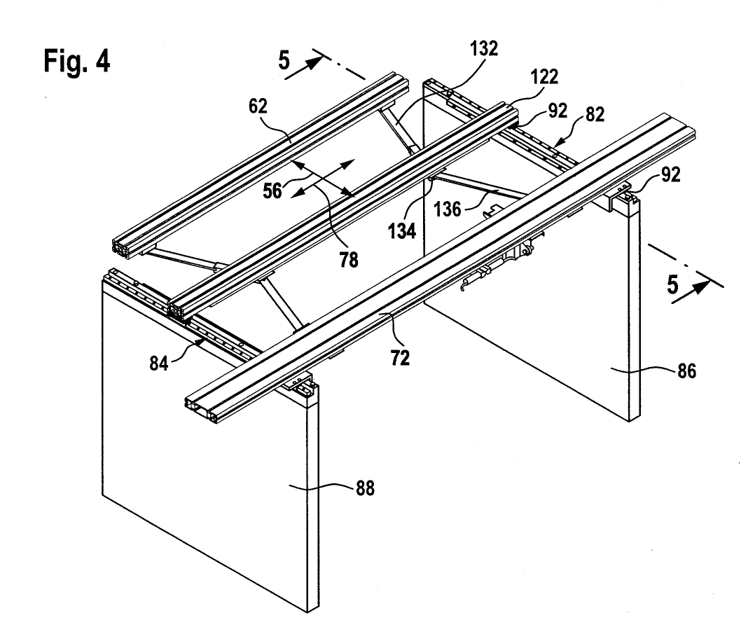

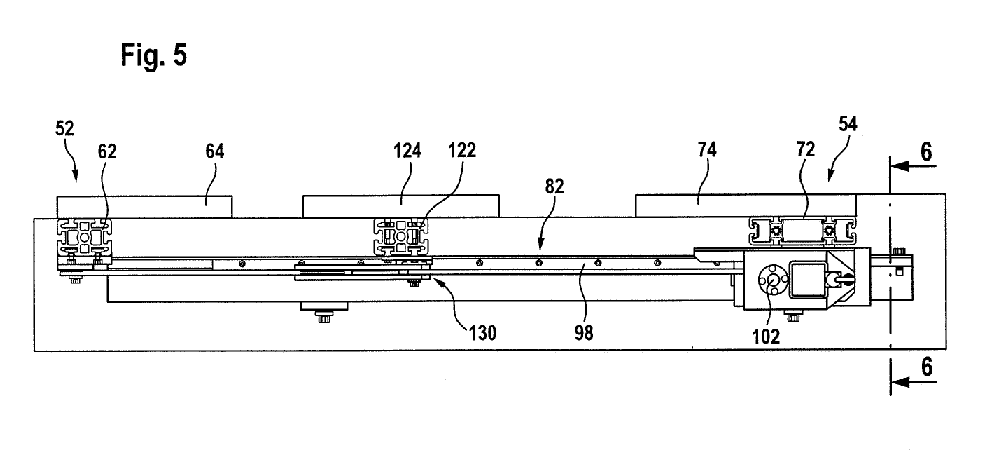

As represented in FIGS. 4 and 5, each of these longitudinal guides 82, 84, in this case the longitudinal guide 82, comprises a longitudinal guide rail 90, in which a guide carriage 92 is guided, for example mounted on roller bearings.

Furthermore, the longitudinal guide rail 90 is seated on a longitudinal member 94, which also carries a rack 96, a pinion 98 meshing with the rack 96 and being rotatably disposed on a bearing body 100, which carries the cross member 72, which bearing body is for its part also seated on the guide carriage 92 and is guided by the latter along the longitudinal guide rail 90.

The bearing body 100 in this case bears a drive shaft 102 of an adjusting drive 110, which is disposed for example on the cross member on a side remote from the supporting plane 30.

The entire cross member 72 is supported on the bearing body 100, and consequently the region 54 remote from the tool is substantially supported on it in the exemplary embodiments represented.

The adjusting drive 110 comprises, for example, an electric drive motor 112 and a gear mechanism 114, and consequently, by driving the pinion 98 via the drive shaft 102, is capable of displacing the cross member 72, and consequently the region 54 remote from the tool, relative to the region 52 that is toward the tool, in the main feed direction 56 and positioning them in defined positions between a minimum extent Aₘᵢₙ and a maximum extent Aₘₐₓ.

Since—as represented in FIG. 3—the cross member 72 carrying the region 54 of the supporting unit 50 that is remote from the tool not only carries the supporting strips 74 but also the stop strips 76, the adjustability of the region 54 remote from the tool, and in particular of the cross member 72, is at the same time used to position the stop strips 76, and consequently their stop elements 116 and 118 which can be brought into use, to be precise in dependence on the position of the cross member 72 relative to the tools 21 and 23.

For this purpose, the adjusting drive 110 is preferably coupled with a controller 120 for the processing machine, which primarily controls the movement of the lower beam 20 and the upper beam 22 relative to one another and also controls the movement of the folding beam 32 for bending the flat material part 26. Since the position of the flat material part 26 relative to a bending line defined by the lower beam tool 21 and the upper beam tool 23 is decisive for this, the controller 120 also controls the position of the stop elements 116 and 118 relative to the lower beam tool 21 and the upper beam tool 23, and consequently ultimately relative to the bending line defined by these tools 21, 23, by controlling the adjusting drive 110 during the bending of the flat material part by the folding beam 32, the controller 120 selecting and activating those of the stop elements 116, 118 that are suitable on the basis of their distance from the bending line.

Consequently, by virtue of the controller 120 and the resultant positioning of the stop elements 116 or 118, the extent A of the supporting unit 50 in the main feed direction 56 necessarily varies according to the size of the flat material part 26 to be processed, if it is assumed that the flat material part 26 is to be supported on the stop elements 116 or 118 on its side opposite from the side to be bent, in order to position the side to be bent exactly relative to the lower beam tool 21 and the upper beam tool 23.

The variation of the extent A of the supporting unit 50 in the main feed direction 56 between the region 52 toward the tool and the region 54 remote from the tool makes it easily possible for an operator manually to put the flat material parts 26 to be processed in place and lay them against the stop elements 116 or 118, and consequently position them exactly relative to the tools 21, 23 and 36 that are applicable to the processing, an operator having the possibility of always being able to take hold of and displace the flat material part 26 on its region intended for butting against one of the stop elements 116 or 118.

Consequently, the flat material part 26 always remains ergonomically favorably within reach of the person standing in front of the region 54 remote from the tool, in particular near the cross member 72, for the handling on the supporting unit 50.

To provide additional support for the flat material part 26 between the region 52 toward the tool and the region 54 remote from the tool, an intermediate cross member 122 is provided between the cross member 62 and the cross member 72 and for its part carries supporting strips 124.

In this case, the intermediate cross member 122 is always positioned between the cross member 62 and the cross member 72, preferably approximately midway between the two, irrespective of the distance between the cross member 72 and the cross member 62, by a pantograph drive mechanism 130.

As represented in FIG. 4, the pantograph drive mechanism 130 in this case comprises a pantograph lever 132, which is articulatingly connected to the cross member 62 and is also articulatingly connected to a carriage 134, which is guided in the longitudinal direction of the intermediate cross member 122, sliding on the latter.

Also articulatingly mounted on the carriage 134 is a pantograph lever 136, which for its part is articulatingly connected to the cross member 72.

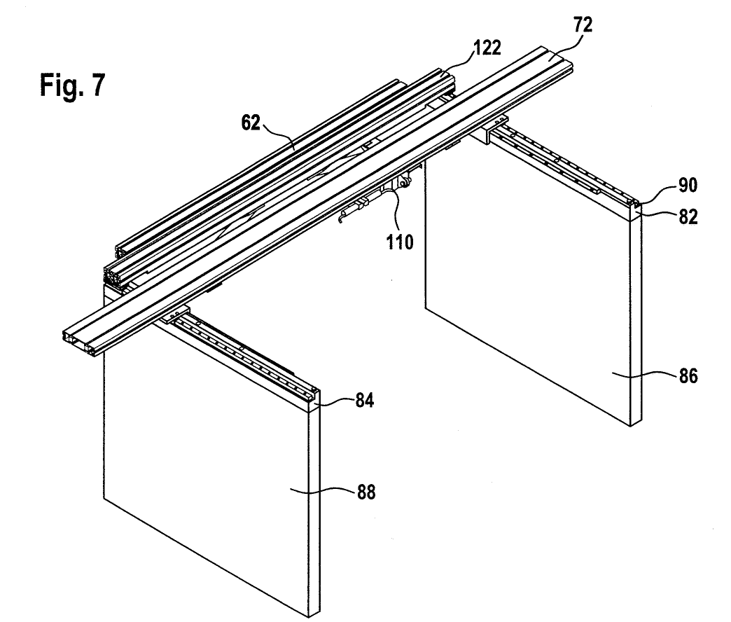

The two pantograph levers 132 and 136 consequently have the effect that the carriage 134, guided in a sliding manner along the intermediate cross member 122, is always positioned in an intermediate position relative to the cross member 62 and the cross member 72, preferably approximately midway between them, the intermediate cross member 122 lying virtually against the cross member 62 and the cross member 72 being disposed at a small distance from the intermediate cross member 122 in the case of the minimal extent of the supporting unit 50, represented in FIG. 7, whereas in the case of the maximum extent of the supporting unit 50, represented in FIG. 4, the cross member 72 is at the maximum distance from the cross member 62 and the intermediate cross member 122 is approximately midway between them, and is kept in this position by the pantograph drive mechanism 130.

In all the intermediate positions between the state of maximum extent of the supporting unit 50 and minimum extent of the supporting unit 50, the pantograph drive mechanism 130 always keeps the intermediate cross member 122 substantially midway between the cross member 72 and the cross member 62.

Preferably, the intermediate cross member 122 is also guided in a sliding manner on the longitudinal guide rail 90 by a corresponding guide carriage 92, so that no additional guidance is required for the movement of the intermediate cross member 122 in the main feed direction 56.

Preferably, as represented in FIGS. 1 and 2, the supporting strips 64, 74 and 124 are disposed on the cross members 62, 72 and 122 in such a way that, in the state of minimum extent of the supporting unit 50 represented in FIGS. 2 and 7, the supporting strips 64, 74 and 134 lie next to one another and do not protrude beyond either the cross member 62 or the cross member 72, whereas in intermediate positions between the state of minimum extent of the supporting unit 50 in the main feed direction 56 and the state of maximum extent of the supporting unit 50 in the main feed direction 56, portions of the supporting strips 64, 74 and 124 lie next to one another, as represented in FIG. 1, so that, as before, adequate support on the supporting unit 50 of the flat material part 26 to be processed can be achieved.

As represented in FIGS. 1 and 2, the supporting unit 50, which is variably adjustable with respect to its extent in the main feed direction 56, does not extend over the entire extent of the processing tools 21, 23 and 36 in the transverse direction 78, but rather only over a partial region of the same.

The supporting unit 50, variable in the main feed direction 56, is preferably further supplemented by supporting tables 142 and 144, which adjoin it on both sides in the transverse direction 78 and carry supporting strips 146 extending over their entire extent in the main feed direction 56.

However, the cross member 72 also extends under the supporting strips 146 of the supporting tables 142 and 144 in order to displace in the main feed direction 56 stop strips 76 disposed between these supporting strips 146, so that the stop strips 76 can together be positioned over the entire extent of the supporting unit 50, and also of the supporting tables 142 and 144 laterally adjoining them in the transverse direction 78, by moving the cross member 72 in the main feed direction 56.

The supporting tables 142 and 144 are preferably formed in such a way that the longitudinal guides 82 and 84 are integrated into them and that the supporting tables 142 and 144 are also respectively carried by the base frames 86 and 88.

To operate the controller 120, an operator unit 126 is disposed on a side of the machine frame 10 that is toward the supporting unit 50—as represented in FIG. 2—and said unit is still within reach of the operator standing in front of the end region 54 remote from the tool, in order to call up the required control programs.

Furthermore, also disposed at the end region 54 remote from the tool is an operating element 128, which can be moved along with the end region 54 and can consequently be actuated in an ergonomically favorable manner, for example for initiating each and every bending operation.

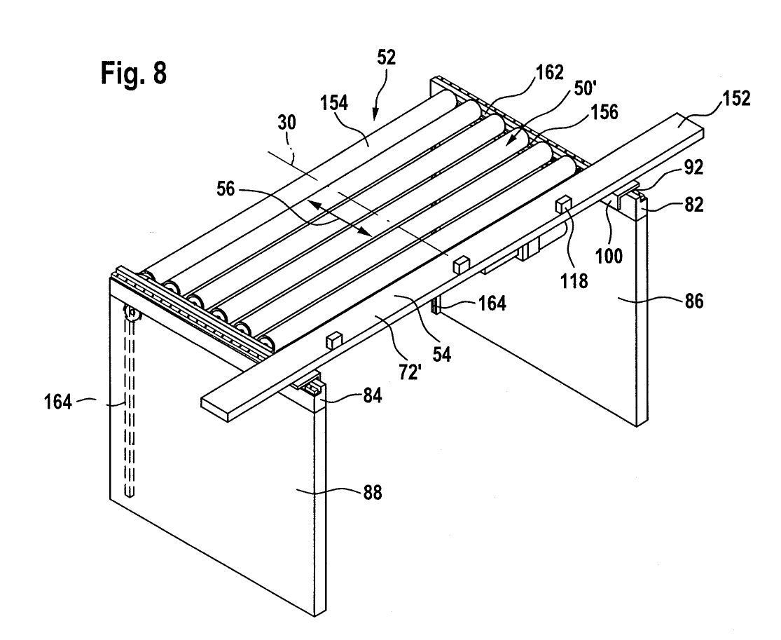

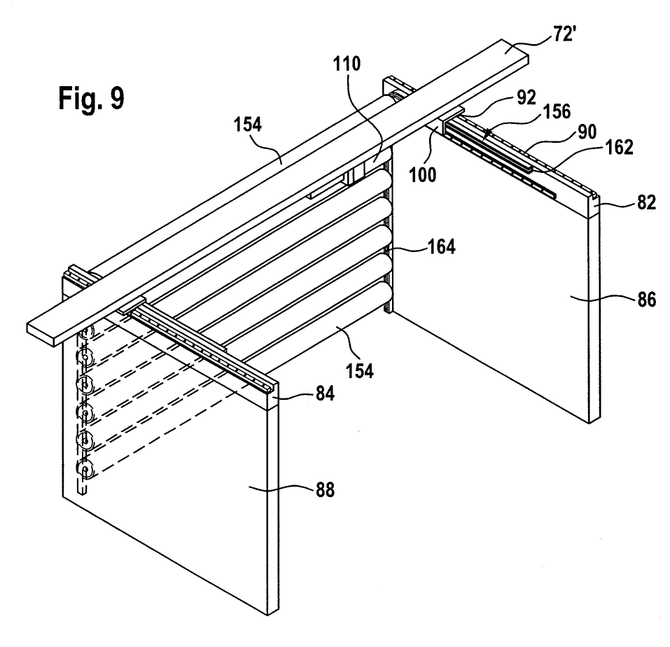

In the case of a second exemplary embodiment of a material-working machine according to the invention, the supporting unit 50′ is disposed on the base frames 86 and 88, as represented in FIGS. 8 and 9, the base frames 86 and 88 respectively carrying a longitudinal guide 82 and 84, which is formed in the same way as in the case of the first exemplary embodiment.

On this longitudinal guide 82 and 84, the cross member 72 is then once again guided by means of guide carriages 92, which are disposed on the bearing body 100.

In the same way as in the case of the first exemplary embodiment, the cross member 72 is movable, but it does not carry any supporting strips 74, but merely stop elements 118, which protrude upward beyond the supporting surface 152 of the cross member 72.

Furthermore, in the case of the second exemplary embodiment of the supporting unit 50′, the supporting plane 30 is formed in addition to the supporting surface 152 by supporting rollers 154, which are disposed such that they follow one another in the main feed direction 56 and are guided in a supporting roller guide 156, the supporting roller guide 156 having a portion 162 running parallel to the main feed direction 56 and a portion 164 running near the lower beam 20, transversely with respect to the portion 162, in which portion 164 the supporting rolls 154 that are not in the portion 162 can be positioned.

The supporting rollers 154 that are respectively in the portion 162 of the supporting roller guide 156 contribute here to supporting the flat material part 26 to be processed in the supporting plane 30, while the other supporting rollers 154 can be stored in the portion 164.

The supporting rollers 154 are in this case connected to one another and to the cross member 72′, for example by tie elements, so that a displacement of the cross member 72′ away from the processing tools 21, 23, 36 has the effect that the supporting rollers 154 are successively drawn up out of the portion 164 into the portion 162 of the supporting roller guide 156 and, by providing guidance in the portion 162, contribute to the supporting plane 30 between the lower beam 20 and the cross member 72′, as represented for example in FIG. 8.

In the state of maximum extent of the supporting unit 50′ in the main feed direction 56, all the supporting rollers 154 are located in the portion 162.

If, on the other hand, the extent of the supporting unit 50′ in the main feed direction 56 is to be minimized, the cross member 72′ is moved in the direction of the processing tools 21, 23, 36 and, as a result, the supporting rollers 154 are transferred one after the other from the portion 162 into the portion 164 of the supporting roller guide 156, the supporting rollers 154 being stored in the portion 164.

Consequently, the supporting roller 154 that is closest to the lower beam 20 while still in the portion 162 forms the region 52 of the supporting unit 50′ that is toward the tool, while the cross member 72′ with the supporting surface 152 forms the region 54 of the supporting unit 50 that is remote from the tool.

1. Processing machine for flat material parts, comprising a machine frame, processing tools held on the machine frame, a supporting unit, on which the flat material part can be placed for feeding to the processing tools in at least one main feed direction, and a controller for controlling a processing sequence using the processing tools, the supporting unit extending in the main feed direction from a region toward the tool to a region remote from the tool and in that the extent between the region toward the tool and the region remote from the tool is variably adjustable.

2. Processing machine according to claim 1, wherein the supporting unit is provided with an adjusting drive adjusting its extent between the region toward the tool and the region remote from the tool.

3. Processing machine according to claim 2, wherein the adjusting drive can be controlled by the controller.

4. Processing machine according to claim 1, wherein the extent of the supporting unit in the main feed direction can be adjusted by means of the controller to correspond to an extent in the main feed direction of the flat material part to be processed.

5. Processing machine according to claim 4, wherein the controller controls the extent of the supporting unit in the main feed direction in such a way that the flat material part to be processed can be placed fully on the supporting unit in the main feed direction.

6. Processing machine according to claim 1, wherein the supporting unit is provided in the region remote from the tool with stop elements for positioning the flat material part.

7. Processing machine according to claim 1, wherein the stop elements are disposed in a positionally fixed manner relative to the region remote from the tool and in that positioning of the stop elements is effected by variation of the extent of the supporting unit in the main feed direction.

8. Processing machine according to claim 6, wherein a number of stop elements at different distances from the processing tools are provided at the region remote from the tool.

9. Processing machine according to claim 8, wherein the various stop elements can be individually activated by the controller.

10. Processing machine according to claim 1, wherein a supporting device that is invariable with respect to its extent in the main feed direction is disposed in a transverse direction with respect to the main feed direction on one side of the adjustable supporting unit.

11. Processing machine according to claim 10, wherein a supporting device that is invariable in the main feed direction is disposed on both sides of the variable supporting unit.

12. Processing machine according to claim 1, wherein the variable supporting unit has a cross member disposed in the region remote from the tool and extending transversely in relation to the main feed direction.

13. Processing machine according to claim 12, wherein the cross member is guided on lateral guides extending in the main feed direction.

14. Processing machine according to claim 12, wherein the cross member is displaceable in the main feed direction, driven by the adjusting drive.

15. Processing machine according to claim 12, wherein the cross member extends up to and into the invariable supporting device.

16. Processing machine according to claim 15, wherein the cross member carries stop elements in the region of the invariable supporting device.

17. Processing machine according to claim 1, wherein intermediate supporting elements are disposed between the region remote from the tool and the region toward the tool.

18. Processing machine according to claim 17, wherein the intermediate supporting elements are coupled with a movement of the region remote from the tool in the main feed direction.

19. Processing machine according to claim 18, wherein the intermediate supporting elements can be moved between the region toward the tool and the region remote from the tool when there is movement of the region remote from the tool in the main feed direction.

20. Processing machine according to claim 17, wherein the intermediate supporting elements are guided on the guides for the cross member.

21.-27. (canceled)

28. Processing machine according to claim 1, wherein the processing tool is movable in a space protected by a housing.

29. Processing machine according to claim 1, wherein an operating side of the processing machine is provided on a side of the machine frame that is toward the supporting unit.

30. Processing machine according to claim 1, wherein the machine frame carries an operating unit for the controller on a side toward the supporting unit.

31. Processing machine according to claim 30, wherein the operating unit is disposed in such a way that it is accessible in an ergonomically favorable manner for an operator standing in front of the region of the supporting unit that is remote from the tool.

32. Processing machine according to claim 1, wherein an operating element that can be moved along with the region remote from the tool is provided for an operator.
